(19) United States
(12) Patent Application Publication
(10) Pub. No.: US 2012/0293413 A1
(43) Pub. Date: Nov. 22, 2012

(54) Method for Controlling Display Device by Using Single Button

(76) Inventor: Li-Jian Luo, Fuqing City (CN)

(21) Appl. No.: 13/110,071

(22) Filed: May 18, 2011

(51) Int. Cl. G09G 5/08

(52) U.S. Cl. 345/160

(57) ABSTRACT

A method for controlling display device by using single button is provided. The method comprises the following steps: pressing a single button so as to turn on the display device when the display device is turned off; pressing the single button for seconds so as to start an On Screen Display (OSD) menu on a screen of the display device when the display device is turned on; after entering the OSD menu, pressing the single button and surfing the OSD menu; continuously pressing the single button so as to actuate a optional function when a cursor is at the optional function of the OSD menu; after actuating the optional function, entering a sub menu and then pressing the single button so as to surf the sub menu, continuously pressing the single button so as to actuate the optional function under the sub menu if the optional function contains the sub menu; pressing the single button so as to control the setting of the optional function if the actuated optional function contains numerical or optional setting; continuously pressing the single button for seconds so as to finish the setting and exit the OSD menu.

### FIELD OF THE INVENTION

The present invention relates to a method for controlling display device, particularly to the method for controlling display device by using single button.

### DESCRIPTION OF THE PRIOR ART

The display device normally has function of On Screen Display (OSD), so as to control the setting of the display device such as voice volume, color contrast or brightness. The OSD is achieved by means of OSD module, so as to start and present OSD menu in the display device; so that the OSD menu might provide several kinds of diagrams, formats, options or numerals to meet the optional function selected by human.

In this manner, the advantages of OSD function are: (1) without progressed by means of computer, so that the exhibition of setting may be directly controlled from the buttons of the display device; (2) without progressed by means of software, so that the voice volume, color contrast or brightness could be easily regulated and controlled.

However, the buttons utilized for OSD controlled are sometimes pluralities, that means higher manufacturing cost and uneasily to operate. Therefore, how to operate OSD function by means of fewer buttons, so as to reduce the manufacturing cost and raise operation for OSD function, is critical issue needed to be settled.

### SUMMARY OF THE INVENTION

The primary object of present invention is to provide a method for controlling display device by using single button, so that the display device may be operated or controlled by means of fewer buttons and therefore the manufacturing cost is reduced.

To achieve the foregoing and other objects, a method for controlling display device by using single button is provided. The method comprises the following steps: pressing a single button so as to turn on the display device when the display device is turned off; pressing the single button for seconds so as to start an On Screen Display (OSD) menu on a screen of the display device when the display device is turned on; after entering the OSD menu, pressing the single button and surfing the OSD menu; continuously pressing the single button so as to actuate a optional function when a cursor is at the optional function of the OSD menu; after actuating the optional function, entering a sub menu and then pressing the single button so as to surf the sub menu, continuously pressing the single button so as to actuate the optional function under the sub menu if the optional function contains the sub menu; pressing the single button so as to control the setting of the optional function if the actuated optional function contains numerical or optional setting; continuously pressing the single button for seconds so as to finish the setting and exit the OSD menu.

In the aforementioned method for controlling display device, wherein the function the cursor is located present colored and the other functions present gray.

In the aforementioned method for controlling display device, wherein the setting of the optional function contains function of increasing value, reducing value, positive confirmation, negative confirmation, start or shot down.

In the aforementioned method for controlling display device, wherein the OSD menu has a revealing data corresponded and stored in a memory; the memory might be Non-Volatile Random Access Memory (NVRAM) or Flash Memory.

Whereby, the method for controlling display device may actuate OSD module by utilizing single button, so as to start the OSD menu and operate the setting of the optional function of the OSD menu. In this manner, the display device may be controlled and regulated by means of fewer buttons, so that the manufacturing cost is reduced and eventually the competitiveness is raised.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is functional diagram of display device;

FIG. 2 is flow chart of starting OSD menu on the screen of the display device;

FIG. 3 is flow chart of controlling display device by means of single button.

### DESCRIPTION OF THE PREFERRED EMBODIMENTS

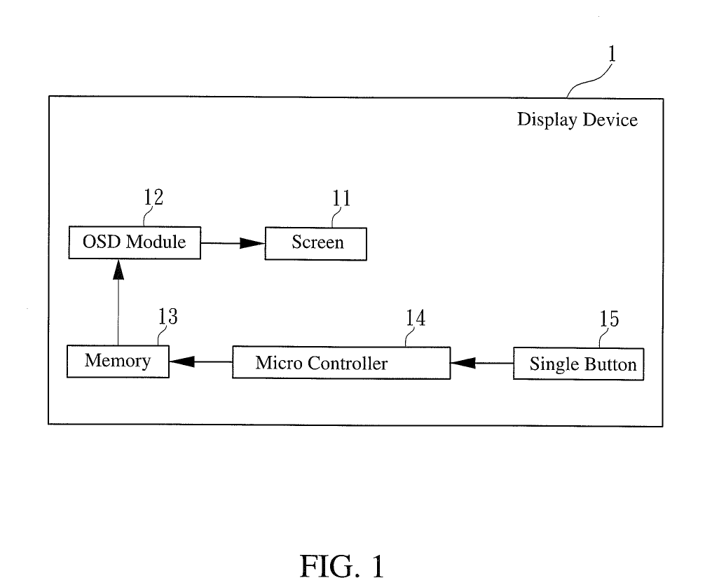

The present invention relates to a method for controlling display device. FIG. 1 is functional diagram of display device; as shown in FIG. 1, the display device 1 comprises a screen 11, an On Screen Display (OSD) module 12, a memory 13, a micro controller 14 and a single button 15. The OSD module 12 may reveal or present an OSD menu on the screen 11. The OSD module 12 may receive OSD signal or OSD information, e.g. voice volume, color contrast or brightness, by means of Inter Integrated Circuit (IIC) bus. Then the OSD module 12 may start and reveal the OSD menu on the screen 11 according to the OSD signal or OSD information. The memory 13 could be Non-Volatile Random Access Memory (NVRAM) or Flash Memory. The memory 13 electrically connects to the OSD module 12, so as to store the OSD signal or OSD information. The micro controller 14 electrically connects to the memory 13. When the micro controller 14 is actuated, it may recognize the actuated signal and then control the memory 13 according to the actuated signal. Afterward, the OSD information corresponded to the memory 13 is transferred to the OSD module 12. The single button 15 electrically connects to the micro controller 14, so that the single button 15 is utilized to actuate the micro controller 14.

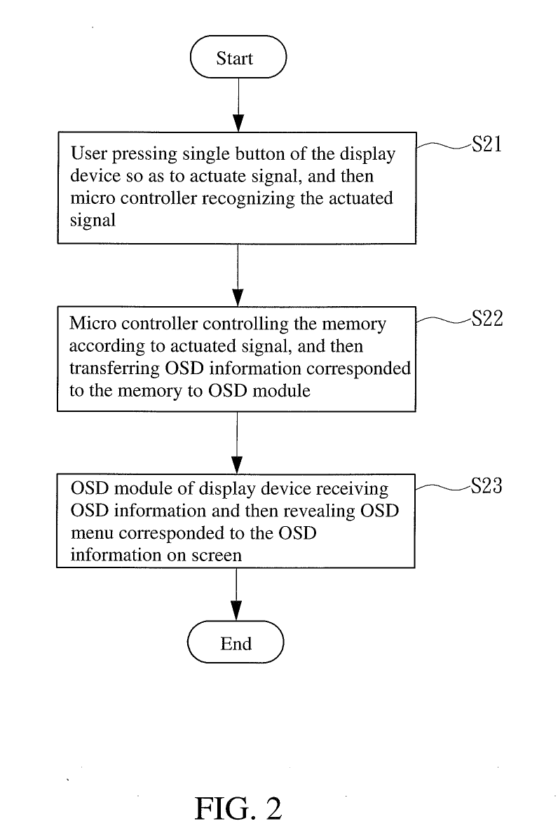

FIG. 2 is flow chart of starting OSD menu on the screen of the display device. Please simultaneously refer to FIG. 1 and FIG. 2, step S21 of present invention is: user pressing the single button 15 of the display device 1 so as to actuate signal, and then the micro controller 14 recognizing the actuated signal;

step S22: the micro controller 14 controlling the memory 13 according to the actuated signal, and then transferring the OSD information corresponded to the memory 13 to the OSD module 12;

step S23: the OSD module 12 of display device 1 receiving the OSD information and then revealing the OSD menu corresponded to the OSD information on the screen 11.

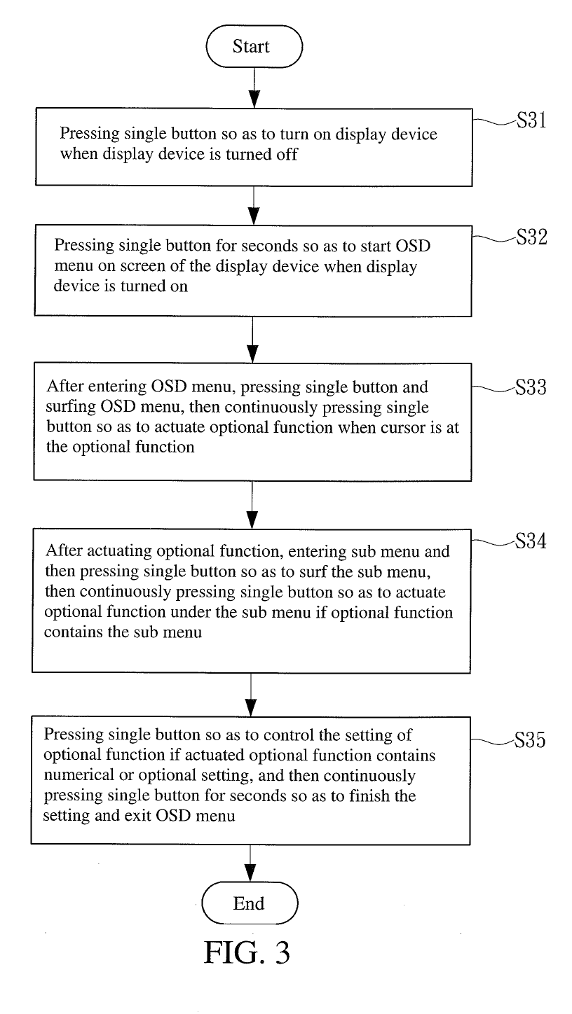

FIG. 3 is flow chart of controlling display device by means of single button. As shown in FIG. 1 and FIG. 3, the method further contains the step S31: pressing the single button 15 so as to turn on the display device 1 when the display device 1 is turned off;

step S32: pressing the single button 15 for seconds so as to start the OSD menu on the screen 11 of the display device 1 when the display device 1 is turned on;

step S33: after entering the OSD menu, pressing the single button 15 and surfing the OSD menu; afterward, continuously pressing the single button 15 so as to actuate a optional function when a cursor is at the optional function of the OSD menu; wherein the function the cursor is located present colored and the other functions present gray;

step S34: after actuating the optional function, entering a sub menu and then pressing the single button 15 so as to surf the sub menu, then continuously pressing the single button 15 so as to actuate the optional function under the sub menu if the optional function contains the sub menu;

step S35: pressing the single button 15 so as to control the setting of the optional function if the actuated optional function contains numerical or optional setting, e.g. the setting of the optional function containing function of increasing value, reducing value, positive confirmation, negative confirmation, start or shot down; afterward continuously pressing the single button 15 for seconds so as to finish the setting and exit the OSD menu.

Descriptively, the OSD menu might have brightness option; when the cursor is stayed and located at the brightness option of the OSD menu, the brightness option could present colored and the other functions present gray. In this manner, user may see the colored mark and therefore aware of where to be actuated by means of continuously pressing the single button 15. Practically, the brightness option does not have sub menu, but contains numerical setting. When the brightness option is actuated, a numeral selection such as integer from 0˜100 could be indicated to the brightness and thus might be regulated by user. In this manner, the brightness may be controlled by pressing single button 15 so as to increase value or reduce value. Preferably, the value can go back to 0 if the increasing value exceeds 100, or the value can go to 100 if the reducing value exceeds 0.

Summarily, the method for controlling display device may actuate OSD module by using single button, so as to start and present OSD menu on the screen, and control the optional functions revealed on the OSD menu. In this manner, the display device may be operated or controlled by means of fewer buttons and therefore the manufacturing cost is reduced.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

I claim:

1. A method for controlling display device by using single button, comprising:
pressing a single button so as to turn on the display device when the display device is turned off;
pressing the single button for seconds so as to start an On Screen Display (OSD) menu on a screen of the display device when the display device is turned on;
after entering the OSD menu, pressing the single button and surfing the OSD menu;
continuously pressing the single button so as to actuate a optional function when a cursor is at the optional function of the OSD menu;
after actuating the optional function, entering a sub menu and then pressing the single button so as to surf the sub menu, continuously pressing the single button so as to actuate the optional function under the sub menu if the optional function contains the sub menu;
pressing the single button so as to control the setting of the optional function if the actuated optional function contains numerical or optional setting;
continuously pressing the single button for seconds so as to finish the setting and exit the OSD menu.

2. The method for controlling display device as claim 1, wherein the function the cursor is located present colored and the other functions present gray.

3. The method for controlling display device as claim 1, wherein the setting of the optional function contains function of increasing value, reducing value, positive confirmation, negative confirmation, start or shot down.

4. The method for controlling display device as claim 1, wherein the OSD menu has a revealing data corresponded and stored in a memory.

5. The method for controlling display device as claim 4, wherein the memory is Non-Volatile Random Access Memory (NVRAM).

6. The method for controlling display device as claim 4, wherein the memory is Flash Memory.
